(19) United States
(12) Patent Application Publication
(10) Pub. No.: US 2026/0257464 A1
(43) Pub. Date: Sep. 3, 2026

(54) PROCESS FOR PREPARATION OF A MULTILAYER FLEXIBLE PACKAGING MATERIAL DELAMINATABLE BY TREATMENT IN WATER

(71) Applicant: SOCIETA' AZIONARIA PER L'INDUSTRIA CHIMICA ITALIANA S.A.P.I.C.I. S.P.A., Milano (IT)

(72) Inventors: Attilio BORLENGHI, Cernusco sul Naviglio (MI) (IT); Matteo NERI MARI, Cernusco sul Naviglio (MI) (IT); Guglielmo CATEL, Cernusco sul Naviglio (MI) (IT)

(21) Appl. No.: 19/163,278

(22) PCT Filed: Mar. 8, 2024
(86) PCT No.: PCT/IB2024/052254

§ 371 Date: Sep. 8, 2025

(30) Foreign Application Priority Data
Mar. 9, 2023 (IT) 102023000004422

(51) Int. Cl. B32B 38/00; B32B 7/12; B32B 27/08; B32B 27/32; B32B 27/36; B32B 37/12

(52) U.S. Cl. CPC B32B 38/00; B32B 7/12; B32B 27/08; B32B 27/32; B32B 27/36; B32B 37/12; B32B 2250/02; B32B 2250/24; B32B 2255/10; B32B 2255/26; B32B 2307/7166

(57) ABSTRACT

A process for preparation of a multilayer flexible packaging material that is selectively delaminated by treatment with water, wherein the method includes the following steps
a) providing a polar polymer layer and a non-polar polymer layer;
b) coating at least one of the layers, namely the one intended to be selectively recycled, with a polyvinyl alcohol (ethylene-vinyl alcohol) copolymer, partly crosslinkable with water-dispersible polyisocyanate; and
c) bonding the coated layers obtained in step b) using a 2K polyurethane adhesive.

### CROSS-REFERENCE TO RELATED APPLICATIONS

This application is a 35 U.S.C. § 371 National Stage patent application of PCT/IB2024/052254, filed on 8 Mar. 2024, which claims the benefit of Italian patent application no. 102023000004422, filed on 9 Mar. 2023, the disclosures of which are incorporated herein by reference in their entirety.

### TECHNICAL FIELD

The disclosure relates to a process for preparation of a multilayer flexible packaging material that is selectively delaminated by treatment with water.

### BACKGROUND

Recycling of flexible food packaging is an important process in order to reduce the environmental impact of said materials and promote a circular economy.

Flexible food packaging often consists of composite materials, such as laminated plastic and aluminium, which can be difficult to recycle. However, various technologies are available to separate said materials and recover their component parts, such as recyclable aluminium or plastic.

The recycling process for flexible food packaging usually involves separating and cleaning the materials. The materials can then be transformed into new products, such as shopping bags, irrigation pipes or new food packaging.

It should be noted that recycling flexible food packaging is not the only solution for reducing its environmental impact. The use of alternative, more sustainable materials, such as biodegradable or compostable materials, should also be considered.

Consumers should also be educated about the importance of correct recycling and correct disposal of flexible food packaging, in order to increase the amount of materials recovered and reduce their environmental impact.

Composite plastic flexible packaging is used for a wide range of products, including foods, beverages and personal care products. However, its composite nature makes it difficult to recycle, because it often contains different types of plastic, aluminium and other components. Recycling such packaging is therefore a major challenge, but necessary to reduce the environmental impact deriving from its manufacture and disposal. Various recycling techniques exist which can be used for said packaging, such as aluminium recovery, separation of plastics or transformation into new products, such as urban paving or decor.

Even when the structure consists of a single material, such as multilayer polypropylene or polyethylene, the presence of further components, such as ink, adhesive and various additives, limits the possibility of recycling it, because the material obtained is not transparent, but very often dark coloured and contaminated by ink, adhesives and other substances.

Numerous attempts have therefore been made to separate and regenerate the original materials by chemical or mechanical methods.

Chemical recycling, wherein polymers are converted to oligomers or monomers by thermal degradation or another process, produces good results, but with the drawback of a level of energy use that significantly affects its carbon footprint.

Conversely, mechanical recycling suffers from the problem of contamination by inks, adhesives and additives, making it impossible to reuse the granulate obtained to manufacture virgin material, because of its poor colour and contaminants.

EP 1973733 B1 describes structures for multilayer laminated packaging characterised by resistance to heat treatment.

WO 2023277861 A1 describes a recyclable film comprising a first film and a second film laminated to the first. The first film includes a first polypropylene layer, a second polypropylene layer, and an ethylene-vinyl alcohol (EVOH) layer between the first and second polypropylene layers. The ethylene-vinyl alcohol layer improves the barrier effect towards oxygen and UV rays.

Methods for recycling multilayer structures were described in EP 3725485.

WO 2022037891 A1 relates to a recyclable multilayer packaging monomaterial comprising a plurality of polypropylene-containing layers, wherein at least one of the polypropylene-containing layers is bonded to two neighbouring layers by different adhesives.

EP 3885095 A1 describes a method for recycling multimaterial laminates, using mixtures of water and essential oils to improve the sustainability of the recycling process.

### SUMMARY

The present disclosure aims to solve the problem of recycling multilayer material used for flexible packing by separating its components so that they can easily be reused.

The problem was solved by a preparation process for a multilayer flexible packing material which comprises coating, with a polyvinyl alcohol ethylene-vinyl alcohol copolymer, at least one of two polymer layers characterised by different polarities, which are then bonded by means of a suitable polyurethane adhesive.

In a first aspect thereof, the object of the disclosure is therefore a process for preparation of a multilayer flexible packaging material which is selectively delaminated by treatment with water, said process comprising:
a) providing a polar polymer layer and a non-polar polymer layer;
b) coating at least one of said layers with a polyvinyl alcohol ethylene-vinyl alcohol copolymer;
c) bonding the coated layers obtained in step b) with a 2K polyurethane adhesive.

The material obtained by the process according to the disclosure can be selectively delaminated by separating the individual layers of the structure by treatment in hot water (60-95° C.) with the aid of non-ionic surfactants and/or in the presence of alkali.

The selective delamination process constitutes a further object of the disclosure.

The containers made of the material obtainable from the process according to the disclosure can thus be collected after use and sent to the delamination unit, wherein the individual materials can be separated by sedimentation due to their different densities. Once separated, the fraction of granulate originating from the coated plastic film is perfectly clean, and can be processed in conventional plastic recycling units.

The polar polymer layer is typically a polyester, typically polyethylene terephthalate or polylactic acid.

The non-polar polymer layer is typically selected from polypropylene (biaxially oriented, amorphous or extruded), low- or high-density polyethylene. Polyvinyl chloride (PVC) and oriented polyamide can also be used. The thickness of the two layers typically ranges between 10 and 1000 nm.

Polyethylene terephthalate is preferred as the polymer of the polar layer, while extruded polypropylene is preferred as the polymer of the non-polar layer.

The polyvinyl alcohol ethylene-vinyl alcohol copolymer (PVOH/EVOH) used for the coating preferably has a degree of hydrolysis exceeding 98% (mol), determined according to standard EN ISO 3681. In the coating step of one or both of the polar and non-polar states, the copolymer is dissolved in water in the presence of a C2-C6 coalescent alcohol at a concentration ranging from 5.0-20% by weight: The copolymer solution typically has a viscosity ranging from 3000-5000 mPa·s at 23° C. measured with a Brookfield viscometer (4% solid content).

A hydrophilically modified polyisocyanate, with an NCO content ranging between 15% and 23%, viscosity less than 3500 mPa·s, free monomer content less than 1.0%, with a weight percent ranging between 0.1 and 5.0%, can be dispersed in the copolymer solution; the result is partial crosslinking of the copolymer with a consequent increase in the tack of the adhesive, and greater stability of the structure in a wet environment. The ethylene-vinyl alcohol copolymer coating can then be partly crosslinked with water-dispersible polyisocyanate (0.10-5.0% by weight).

The 2K NCO-terminated polyurethane adhesive can be solvent-free or solvent-based.

The solvent-free or solvent-based-NCO component has a viscosity ranging from 100-14000 mPa·s at 23° C., with an NCO content of 4.0-32.0% on a molar basis.

The solvent-free or solvent-based-OH hardener component has a viscosity ranging from 10-8000 mPa·s at 23° C., and an OH value of 30-1000 mg KOH/g.

Application in the laminating machine involves two steps:
1) Coating with PVOH/EVOH aqueous solution, 20-35 m/min, blown air temperature 65-90° C., dry film 1.0-4.0 g/m², curing time 4-14 days at 15-70° C. Both polar film 1 and non-polar plastic film 2 can be coated. A water-dispersible polyisocyanate can be dispersed in the aqueous solution to improve the stability of the structure, at a concentration of 0.1-5.0% of the solid content of said solution.
2) Bonding of the two films using a mixture in the preferred ratio 100 (NCO)/50 (OH), under the following conditions: 50-400 m/min, blown furnace air 45-60° C. in the case of self-supporting adhesive film solvent, dry film 2.0-8.0 g/m², curing in drum 4-10 days at 20-70° C.

### BRIEF DESCRIPTION OF THE DRAWINGS

FIG. 1 illustrates a scheme of the multilayer structure obtained by the process according to the disclosure: reference number 1 indicates the polar film, reference number 2 indicates the non-polar film, reference number 3 indicates the coating layer with ethylene-vinyl alcohol copolymer; and reference numbers 3 and 4 indicate the polyurethane adhesive layer.

FIG. 2 illustrates the elements of the structure after the delamination and recycling process.

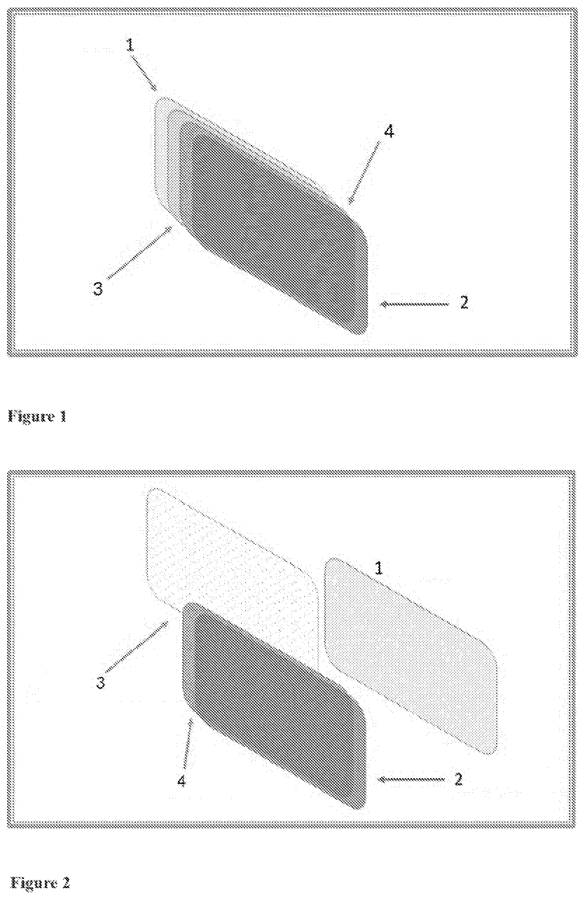

### DETAILED DESCRIPTION OF THE DRAWINGS AND DISCLOSURE

The disclosure is described in greater detail in the examples below.

### Example 1: Combination of Polyethylene Terephthalate (PET) and Cast Polypropylene (CPP)

A PET plastic film (1) with a thickness ranging between 10 and 15μ is coated with 0.5-2.0 g/m² of dried film by spreading a 10% aqueous solution of PVOH/EVOH.

The roll of coated film can be stored for curing: 6-8 days at 25-60° C.

After said step the coated film can be bonded to another plastic film (2) made of CPP, with a thickness ranging between 20 and 30μ, using a 2K polyurethane adhesive system, 4.0-8.0 g/m2.

NCO component: 8000-10000 mPa·s at 23° C., solvent-free, wt % NCO 10-12%.

—OH component: 3500-6500 mPa·s at 23° C., solvent-free, OH. Value 190-215 mg KOH/g.

After a curing time of 4-10 days at 40-60° C. under the pressure of the laminated film roll, the bond strength measurement is surprisingly high, and the two films do not seem to be peelable.

The chopped, crushed material is immersed in hot water (80-90° C.) in the presence or absence of max 0.5% surfactant, in a 7<pH<10 basic solution, for 20-40 minutes.

If the material is washed with fresh water, the two plastics can be separated by flotation: the PET-coated film flakes (1) will be clean and deposited on the base, while the remainder (2) will float, still soiled with adhesive, floating on the surface.

After heat treatment, 1 h at 220°, film flakes (1) still remain clean and clear: no yellowing or browning takes place, as is the case with the plastic flakes obtained from film 2, so there is no evidence of organic residues contaminating the plastic shavings with adhesive. The material can easily be reused.

### Example 2: Combination of Polyethylene Terephthalate (PET) and Cast Polypropylene (CPP)

A CPP plastic film (2) with a thickness ranging between 75 and 85 u is coated with 0.5-2.0 g/m² of dried film, by spreading a 10% aqueous solution of PVOH/EVOH.

The roll of coated film can be stored for curing: 6-8 days at 25-60° C.

After said step the coated film can be bonded to another plastic film (1) made of PET, with a thickness ranging between 10 and 15μ, using a 2K polyurethane adhesive system, 4.0-8.0 g/m2.

NCO component: 8000-10000 mPa·s at 23° C., solvent-free, wt % NCO 10-12%.

—OH component: 3500-6500 mPa·s at 23° C., solvent-free, OH. Value 190-215 mg KOH/g.

After a curing time of 4-10 days at 40-60° C. under the pressure of the laminated film roll, the bond strength measurement is surprisingly high, and the two films do not seem to be peelable.

The chopped, crushed material is immersed in hot water (80-90° C.) in the presence or absence of surfactant not exceeding 0.5% by weight, in a 7<pH<10 basic solution, for 40-60 minutes.

If the material is washed with fresh water, the flakes of the two plastic films can be separated by flotation: those originating from PET film (1) will be deposited on the base, while the others (2) will remain floating on the surface, perfectly clean.

After heat treatment, 1 h at 220°, the flakes from film (2) still remain clean and clear: the plastic shavings are not contaminated with adhesive residues. The material can easily be reused.

This example demonstrates the selectivity of the delamination process.

### Example 3: Sachet Manufacture by Hot-Sealing Structures Consisting of Polyethylene Terephthalate (PET) and Cast Polypropylene (CPP)

A PET plastic film (1), with a thickness ranging between 10 and 15μ, is coated with 0.5-2.0 g/m² of dried film, by spreading a 10% aqueous solution of PVOH/EVOH.

The roll of coated film can be stored for curing: 6-8 days at 25-60° C.

After said step the coated film can be bonded to another plastic film (2) made of CPP, with a thickness ranging between 10 and 40μ, using a 2K polyurethane adhesive system, 4-8 g/m2.

NCO component: 8000-10000 mPa·s at 23° C., solvent-free, wt % NCO 10-12%.

—OH component: 3500-6500 mPa·s at 23° C., solvent-free, OH. Value 190-215 mg KOH/g.

After a curing time of 4-10 days at 40-60° C. under the pressure of the laminated film roll, the bond strength measurement is surprisingly high, and the two films do not seem to be peelable.

The sheets thus obtained were packed and folded into sachets by a hot-sealing process at 150° C.

The sealed areas were then cut and separated from the metal residues.

Only said sealed areas, after chopping and crushing, were immersed in hot water (80-90° C.), in the presence or absence of up to 0.5% surfactant by weight in a 7<pH<10 basic solution, for 20-40 minutes.

If the material is washed with fresh water, the two plastics can be separated by flotation: the PET-coated film flakes (1) will be clean and deposited on the base, while the remainder (2) will float, still soiled with adhesive, floating on the surface.

After heat treatment, 1 h at 220°, film flakes (1) still remain clean and clear: no yellowing or browning takes place, as is the case with the plastic flakes obtained from film 2, so there is no evidence of organic residues contaminating the plastic shavings with adhesive. The material can easily be reused, even in the case of hot-sealing.

### Comparative Example 4: Combination of Biaxially Oriented Polypropylene (BoPP) And Cast Polypropylene (CPP)

A CPP plastic film (2) with a thickness ranging between 15 and 25μ is coated with 0.5-2.0 g/m² of dried film by spreading a 10% aqueous solution of PVOH/EVOH.

The roll of coated film can be stored for curing: 6-8 days at 25-60° C.

After said step the coated film is bonded to another plastic film (2) made of BoPP, with a thickness ranging between 20 and 30μ, using a 2K polyurethane adhesive system, 4.0-8.0 g/m².

NCO component: 8000-10000 mPa·s at 23° C., solvent-free, wt % NCO 10-12%.

—OH component: 3500-6500 mPa·s at 23° C., solvent-free, OH. Value 190-215 mg KOH/g.

After a curing time of 4-10 days at 40-60° C. under the pressure of the laminated film roll, the bond strength measurement is surprisingly high, and the two films do not seem to be peelable.

The chopped, crushed material is immersed in hot water (80-90° C.) in the presence or absence of up to 0.5% surfactant by weight, in a 7<pH<10 basic solution, for 20-40 minutes.

If the material is washed with fresh water, the two plastics cannot be separated by flotation: no delamination whatsoever takes place.

There is no density separation of the various materials, and the COD of the water is the same before and after the treatment, as shown in Table 1.

TABLE 1
COD of washing water

| | |
|---|---|
| COD at Start of Washing with hot water (ppm) | 4434 |
| COD at End of Washing with hot water (ppm) | 4462 |
| COD with detergent (KgO₂/ton) | 267.7 |
| COD w/o detergent (KgO₂/ton) | 1.7 |

This behaviour demonstrates and confirms that only the material obtained by the process according to the disclosure is selectively separable.

### Example 5: Combination of Polyethylene Terephthalate (PET) and Biaxially Oriented Polypropylene (BoPP). Partly Crosslinked Coating

A water-dispersible polyisocyanate, in the amount of 0.5%, with the following characteristics, is dispersed in a 10% aqueous solution of PVOH/EVOH:
NCO content between 15% and 23%
viscosity less than 3500 mPa·s
free monomer content less than 1.0%

A PET plastic film (1) with a thickness ranging between 10 and 15μ is coated with 0.5-2.0 g/m² of dried film by spreading a 10% aqueous solution of PVOH/EVOH.

The roll of coated film can be stored for curing: 6-8 days at 25-60° C.

After said step the coated film can be bonded to another plastic film (2) made of BoPP, with a thickness ranging between 20 and 30μ, using a 2K polyurethane adhesive system, 4.0-8.0 g/m2.

NCO component: 8000-10000 mPa·s at 23° C., solvent-free, wt % NCO 10-12%.

—OH component: 3500-6500 mPa·s at 23° C., solvent-free, OH. Value 190-215 mg KOH/g.

After a curing time of 4-10 days at 40-60° C. under the pressure of the bonded film roll, the bond strength measurement provides results that are twice as high as those not involving the use of water-dispersible polyisocyanate.

If the chopped, crushed material is immersed in hot water (80-90° C.) without surfactants and in a 6.5<pH<7.5 neutral solution for 30 minutes, the structure becomes practically undelaminatable.

1. A process for preparing a multilayer flexible packaging material that is selectively delaminated by treatment with water, said process including the following steps:
a) providing a polar polymer layer and a non-polar polymer layer;
b) coating at least one of said layers with a polyvinyl alcohol/ethylene vinyl alcohol copolymer; and
c) bonding the coated layers obtained in step (b) with a 2K polyurethane adhesive.

2. The process according to claim 1 wherein the ethylene-vinyl alcohol copolymer coating is partly crosslinked with water-dispersible polyisocyanate (0.10-5.0% by weight).

3. The process according to claim 1 wherein the polar polymer layer is selected from polyethylene terephthalate or polylactic acid.

4. The process according to claim 1, wherein the non-polar polymer layer is selected from polypropylene (biaxially oriented, amorphous or extruded) and low- or high-density polyethylene.

5. The process according to claim 4 wherein the non-polar polymer layer comprises cast polypropylene.

6. The process according to claim 1, wherein the polyvinyl alcohol/ethylene vinyl alcohol copolymer has a degree of hydrolysis greater than 98% (mol).

7. The process according to claim 1, wherein the non-polar layer is coated with polyvinyl alcohol/ethylene vinyl alcohol copolymer.

8. The process according to claim 1, wherein the polar layer is coated with polyvinyl alcohol/ethylene vinyl alcohol copolymer.

9. The process according to claim 1, wherein both the polar layer and the non-polar layer are coated with polyvinyl alcohol/ethylene vinyl alcohol copolymer.

10. The process according to claim 1, wherein the coating of step b) is carried out by coating the layers with an aqueous solution of polyvinyl alcohol/ethylene vinyl alcohol copolymer in the presence of a C2-C6 coalescent alcohol at a concentration ranging from 5.0 to 20% by weight.

11. The process according to claim 1, wherein the aqueous solution of ethylene-vinyl alcohol copolymer is partly crosslinked by addition of 0.10-5.0% of water-dispersible polyisocyanate:
NCO content ranging between 15% and 23%;
viscosity less than 3500 mPa·s measured with a Brookfield viscometer at 23° C.; and
free monomer content less than 1.0%.

12. The process according to claim 1, wherein the NCO-terminated 2K polyurethane adhesive may be solvent-free or solvent-based.

13. The process according to claim 12 wherein the adhesive comprises an—NCO component having a viscosity ranging from 100 to 14000 mPa·s at 23° C., with an NCO content of 4.0-32.0% on a molar basis and an—OH hardener component with viscosity ranging from 10 to 8000 mPa·s at at 23° C., and an OH value of 30-1000 mgKOH/g.

14. A multilayer flexible packaging material obtainable by the process of claim 1.
